(19) United States
(12) Patent Application Publication
(10) Pub. No.: US 2019/0340776 A1
(43) Pub. Date: Nov. 7, 2019

(54) DEPTH MAP INTERPOLATION USING GENERALIZED LIKELIHOOD RATIO TEST PARAMETER ESTIMATION OF A CODED IMAGE

(71) Applicant: QUALCOMM Incorporated, San Diego, CA (US)

(72) Inventors: James Nash, San Diego, CA (US); Hasib Siddiqui, San Diego, CA (US); Kalin Atanassov, San Diego, CA (US); Justin Cheng, San Diego, CA (US)

(21) Appl. No.: 16/107,901

(22) Filed: Aug. 21, 2018

Related U.S. Application Data
(60) Provisional application No. 62/667,268, filed on May 4, 2018.

(51) Int. Cl. G06T 7/521; G06T 7/11

(52) U.S. Cl. CPC G06T 7/521; G06T 7/11; G06T 2207/20021; G06T 2207/20024; G06T 2207/10028

(57) ABSTRACT

Aspects of the present disclosure relate to systems and methods for structured light (SL) depth systems. An example method for determining a depth map post-processing filter may include receiving an image including a scene superimposed on a codeword pattern, segmenting the image into a plurality of tiles, estimating a codeword for each tile of the plurality of tiles, estimating a mean scene value for each tile based at least in part on the respective estimated codeword, and determining the depth map post-processing filter based at least in part on the estimated codewords and the mean scene values.

### CROSS-REFERENCE TO RELATED PATENT APPLICATIONS

This application claims priority to U.S. Provisional Patent Application No. 62/667,268 entitled “DEPTH MAP INTERPOLATION USING GENERALIZED LIKELIHOOD RATIO TEST PARAMETER ESTIMATION OF A CODED IMAGE” filed on May 4, 2018, which is assigned to the assignee hereof. The disclosure of the prior application is considered part of and is incorporated by reference in this patent application.

### TECHNICAL FIELD

This disclosure relates generally to systems and methods for structured light systems, and specifically to processing of depth maps generated by structured light systems.

### BACKGROUND OF RELATED ART

A device may determine distances of its surroundings using different depth finding systems. In determining the depth, the device may generate a depth map illustrating or otherwise indicating the depths of objects from the device by transmitting one or more wireless signals and measuring reflections of the wireless signals. One depth finding system is a structured light system.

For a structured light system, a known pattern of points is transmitted (such as near-infrared or other frequency signals of the electromagnetic spectrum), and the reflections of the pattern of points is measured and analyzed to determine depths of objects from the device.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to systems and methods for structured light (SL) depth systems. In one example implementation, a method for determining a depth map post-processing filter is disclosed. The example method may include receiving an image including a scene superimposed on a codeword pattern, segmenting the image into a plurality of tiles, estimating a codeword for each tile of the plurality of tiles, estimating a mean scene value for each tile based at least in part on the respective estimated codeword, and determining the depth map post-processing filter based at least in part on the estimated codewords and the mean scene values.

In another example, a device is disclosed. The example device includes one or more processors, and a memory coupled to the one or more processors and including instructions that, when executed by the one or more processors, cause the device to determine a depth map post-processing filter for a structured light (SL) system by receiving an image including a scene superimposed on a codeword pattern, segmenting the image into a plurality of tiles, estimating a codeword for each tile of the plurality of tiles, estimating a mean scene value for each tile based at least in part on the respective estimated codeword, and determining the depth map post-processing filter based at least in part on the estimated codewords and the mean scene values.

In a further example, a non-transitory computer-readable medium is disclosed. The non-transitory computer-readable medium may store instructions that, when executed by a processor, cause a device to receive an image including a scene superimposed on a codeword pattern, segment the image into a plurality of tiles, estimate a codeword for each tile of the plurality of tiles, estimate a mean scene value for each tile based at least in part on the respective estimated codeword, and determine a depth map post-processing filter based at least in part on the estimated codewords and the mean scene values.

In another example, a device is disclosed. The device includes means for receiving an image including a scene superimposed on a codeword pattern, means for segmenting the image into a plurality of tiles, means for estimating a codeword for each tile of the plurality of tiles, means for estimating a mean scene value for each tile based at least in part on the respective estimated codeword, and means for determining a depth map post-processing filter based at least in part on the estimated codewords and the mean scene values.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1 is an example structured light system.

FIG. 2 is a block diagram of an example device including a structured light system.

FIG. 3 depicts example problems which may be reflected in depth maps generated by structured light systems.

FIG. 4 is a depiction of an image as measured or sensed by a receiver, the image including the codeword pattern, ambient light from the scene, and noise or interference.

FIG. 5 shows a generalized likelihood ratio test (GLRT) mean value estimate of an ambient scene and an overlay of the GLRT mean value estimate with a depth map of the scene, according to the example implementations.

FIG. 6 depicts a comparison of depth maps processed according to conventional techniques with a depth map processed according to some example implementations.

FIG. 7 is an illustrative flow chart depicting an example operation for determining a depth map post-processing filter for a structured light system, according to the example implementations.

### DETAILED DESCRIPTION

Aspects of the present disclosure may be used for structured light (SL) systems for determining depths. More particularly, a post-processing filter may be determined for enhancing raw depth maps generated by such structured light systems. For each tile (or patch) of a received image, the index of the codeword may be estimated, and used for estimating a generalized likelihood ratio test (GLRT) mean value of the ambient scene at that tile. The estimated scene values at each tile may then be used for constructing a guide image which is highly correlated with the depth map. The post-processing filter may be based on this guide image.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic device (such as security systems, smartphones, tablets, laptop computers, vehicles, drones, or other devices) with are coupled to one or more structured light systems. While described below with respect to a device having or coupled to one structured light system, aspects of the present disclosure are applicable to devices having any number of structured light systems (including none, where structured light information is provided to the device for processing), and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

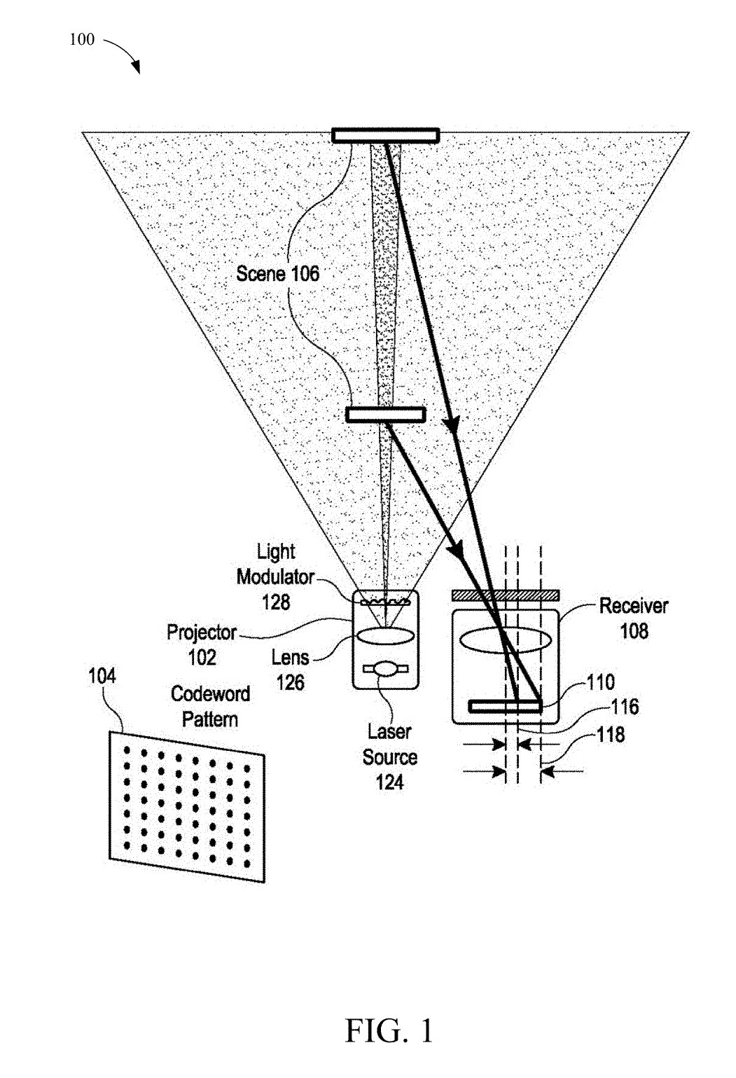

FIG. 1 is an example structured light system 100. The structured light system 100 may be used to generate a depth map (not pictured) of a scene 106. The structured light system 100 may include at least a projector or transmitter 102 and a receiver 108. The projector or transmitter 102 may be referred to as a “transmitter,” “projector,” “emitter,” and so on, and should not be limited to a specific transmission component. Similarly, the receiver 108 may also be referred to as a “detector,” “sensor,” “sensing element,” “photodetector,” and so on, and should not be limited to a specific receiving component.

The transmitter 102 may be configured to project a codeword pattern 104 onto the scene 106. In some example implementations, the transmitter 102 may include one or more laser sources 124, a lens 126, and a light modulator 128. In some embodiments, the transmitter 102 can further include a diffractive optical element (DOE) to diffract the emissions from one or more laser sources 124 into additional emissions. In some aspects, the light modulator 128 (such as to adjust the intensity of the emission) may comprise a DOE. The codeword pattern 104 may be hardcoded on the structured light system 100 (e.g., at the projector 102). The transmitter 102 may transmit one or more lasers from the laser source 124 through the lens 126 (and/or through a DOE or light modulator 128) and onto the scene 106. As illustrated, the transmitter 102 may be positioned on the same reference plane as the receiver 108, and the transmitter 102 and the receiver 108 may be separated by a distance called the “baseline.”

The receiver 108 may be configured to detect (or “sense”), from the scene 106, a reflection 110 of the codeword pattern 104. The reflection 110 may include multiple reflections of the codeword pattern from different objects or portions of the scene 106 at different depths. Based on the baseline, displacement and distortion of the reflected codeword pattern 104, and intensities of the reflections 110, the structured light system 100 may be used to determine one or more depths and locations of objects from the structured light system 100. For example, locations and distances of transmitted light points in the projected codeword pattern 104 from light modulator 128 and corresponding locations and distances of light points in the reflection 110 received by a sensor of receiver 108 (such as distances 116 and 118 from the center to the portion of reflection 110) may be used to determine depths and locations of objects in the scene 106.

In some example implementations, the receiver 108 may include an array of photodiodes (such as avalanche photodiodes) to measure or sense the reflections. The array may be coupled to a complementary metal-oxide semiconductor sensor including a number of pixels or regions corresponding to the number of photodiodes in the array. The plurality of electrical impulses generated by the array may trigger the corresponding pixels or regions of the CMOS sensor to provide measurements of the reflections sensed by the array. Alternatively, a photosensitive CMOS sensor may sense or measure reflections including the reflected codeword pattern. The CMOS sensor logically may be divided into groups of pixels (such as 4×4 groups) that correspond to a size of a bit of the codeword pattern. The group (which may also be of other sizes, including one pixel) is also referred to as a bit.

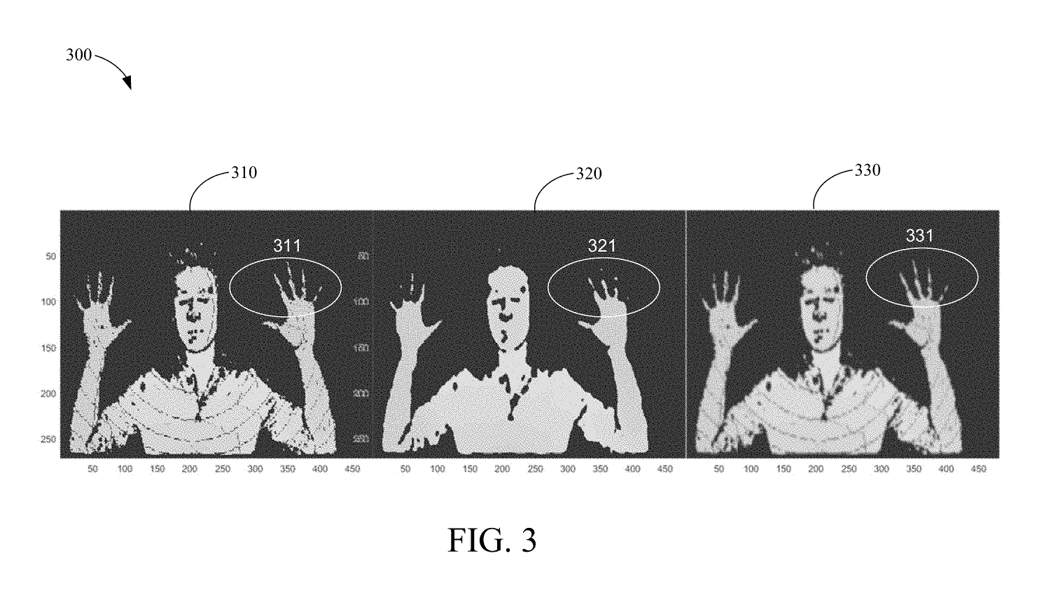

As illustrated, the distance 116 corresponding to the reflected light point of the codeword pattern 104 at the further distance of the scene 106 is less than the distance 118 corresponding to the reflected light point of the codeword pattern 104 at the closer distance of the scene 106. Using triangulation based on the baseline and the distances 116 and 118, the structured light system 100 may be used to determine the differing distances of the scene 106 and to generate a depth map of the scene 106. The calculations may further include determining displacement or distortion of the codeword pattern 104, as described below in connection with FIG. 3.

Although a number of separate components are illustrated in FIG. 1, one or more of the components may be implemented together or include additional functionality. All described components may also not be required for a structured light system 100, or the functionality of components may be separated into separate components. Therefore, the present disclosure should not be limited to the example structured light system 100.

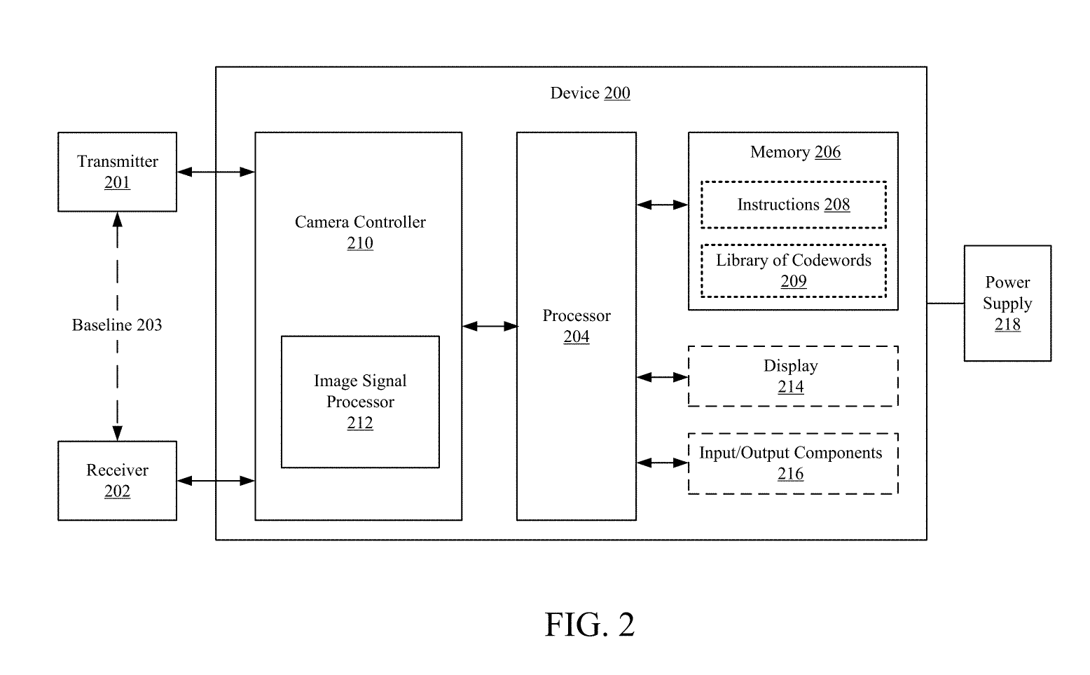

FIG. 2 is a block diagram of an example device 200 including a structured light system. In some other examples, the structured light system may be coupled to the device 200 or information from a structured light system may be provided to device 200 for processing. The example device 200 may include or be coupled to a transmitter 201 (such as transmitter 102 in FIG. 1), a receiver 202 (such as receiver 108 in FIG. 1) separated from the transmitter by a baseline 203, a processor 204, a memory 206 storing instructions 208, and a camera controller 210 (which may include at least one image signal processor (ISP) 212). The device 200 may optionally include (or be coupled to) a display 214 and a number of input/output (I/O) components 216. The device 200 may include additional features or components not shown. For example, a wireless interface, which may include a number of transceivers and a baseband processor, may be included for a wireless communication device. The transmitter 201 and the receiver 202 may be part of a structured light system (such as structured light system 100 in FIG. 1) controller by the camera controller 210 and/or the processor 204. The device 200 may include or be coupled to additional structured light systems or a different configuration for the structured light system. For example, the device 200 may include or be coupled to additional receivers (not shown) for calculating distances and locations of objects in a scene). The disclosure should not be limited to any specific examples or illustrations, including the example device 200.

The memory 206 may be a non-transient or non-transitory computer readable medium storing computer-executable instructions 208 to perform all or a portion of one or more operations described in this disclosure. The memory 206 may also store a library of codewords or light patterns 209 to be used in identifying codewords in measured reflections by receiver 202. The device 200 may also include a power supply 218, which may be coupled to or integrated into the device 200.

The processor 204 may be one or more suitable processors capable of executing scripts or instructions of one or more software programs (such as instructions 208) stored within the memory 206. In some aspects, the processor 204 may be one or more general purpose processors that execute instructions 208 to cause the device 200 to perform any number of functions or operations. In additional or alternative aspects, the processor 204 may include integrated circuits or other hardware to perform functions or operations without the use of software. While shown to be coupled to each other via the processor 204 in the example of FIG. 2, the processor 204, the memory 206, the camera controller 210, the optional display 214, and the optional I/O components 216 may be coupled to one another in various arrangements. For example, the processor 204, the memory 206, the camera controller 210, the optional display 214, and/or the optional I/O components 216 may be coupled to each other via one or more local buses (not shown for simplicity).

The display 214 may be any suitable display or screen allowing for user interaction and/or to present items (such as a depth map or a preview image of the scene) for viewing by a user. In some aspects, the display 214 may be a touch-sensitive display. The I/O components 216 may be or include any suitable mechanism, interface, or device to receive input (such as commands) from the user and to provide output to the user. For example, the I/O components 216 may include (but are not limited to) a graphical user interface, keyboard, mouse, microphone and speakers, squeezable bezel or border of the device 200, physical buttons located on device 200, and so on. The display 214 and/or the I/O components 216 may provide a preview image or depth map of the scene to a user and/or receive a user input for adjusting one or more settings of the device 200 (such as adjusting the intensity of the emissions by transmitter 201, adjusting the size of the codewords used for the structured light system, and so on).

The camera controller 210 may include an ISP 212, which may be one or more processors to process measurements provided by the receiver 202 and/or control the transmitter 201 (such as control the intensity of the emission). In some aspects, the ISP 212 may execute instructions from a memory (such as instructions 208 from the memory 206 or instructions stored in a separate memory coupled to the ISP 212). In other aspects, the ISP 212 may include specific hardware for operation. The ISP 212 may alternatively or additionally include a combination of specific hardware and the ability to execute software instructions.

As discussed above, the codeword pattern 104 is known by the structured light system 100 in FIG. 1. For example, the codeword pattern 104 may be hardcoded on the structured light system 100 (e.g., at the transmitter 102) so that the same pattern is always projected by the structured light system 100. Referring to FIG. 2, the device 200 may store a library of codewords 209, which may include the possible patterns of the different size codewords throughout all locations of the codeword pattern 104.

Raw depth maps generated using structured light systems may be noisy, and may be missing information. Post-processing may be performed on a raw depth map, and may be configured to retain the signal, while rejecting noise, and interpolating missing values. Such post-processing methods may lead to a number of problems. For example, FIG. 3 is an illustration 300, depicting several errors which may be reflected in raw depth maps and in some post-processing techniques. For example, depth map 310 depicts a raw depth map generated by a structured light system. Depth map 310 includes a number of areas missing signal data. For example, region 311 shows an image of the subject's fingers, which includes noise with portions of the fingers missing from the depth map 310. Depth map 320 depicts a raw depth map which has been median filtered. Such median filtering may reduce noise from the raw depth map, but may also result in lost signal data as compared with raw depth map 310. For example, in region 321 corresponding to region 311, more signal data for the subject's fingers are lost from the depth map 310 to the depth map 320. Depth map 330 depicts a raw depth map which has been filtered with a gaussian filter. While more signal data for the subject's fingers are retained in region 331 as compared with region 321, that all of the subject's fingers are not reflected in the depth map 330. For example, portions of the rightmost finger of region 331 are missing in the depth map 330.

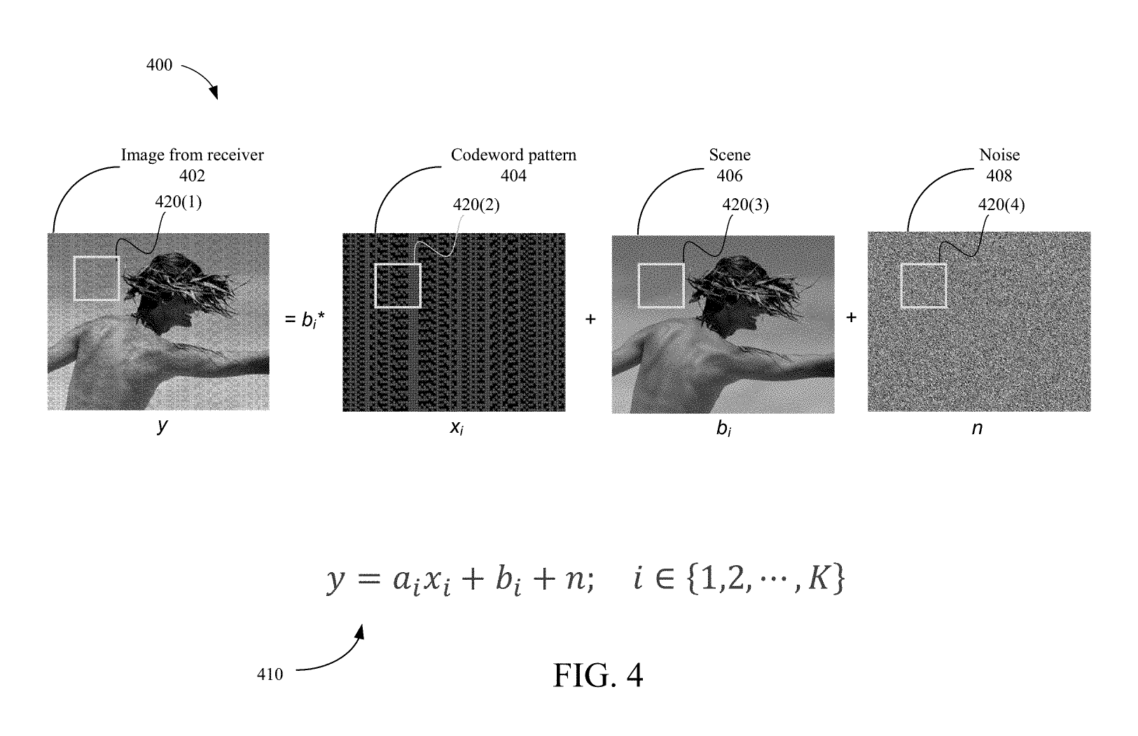

FIG. 4 shows an example model 400 for determining the content of a structured light image (such as image 402) received at a receiver (such as receiver 108 of FIG. 1). The received image 402 may be considered as a superposition of several images, such as a codeword pattern 404, an ambient scene 406, and a noise image 408. Mathematically, each patch of the received image 402, such as patch 420(1), may be based on a corresponding patch of the codeword pattern 404, such as patch 420(2), a corresponding patch of the ambient scene 406, such as patch 420(3), and a corresponding patch of the noise image 408, such as patch 420(4). The relationship between these patches is reflected in equation 410, reproduced below:

y=aᵢxᵢ+bᵢ+n, for i∈{1,2, . . . K}

where y is the patch of the received image, xᵢ is the i-th codeword among K total codewords, aᵢ ∈ (0,1) is an attenuation factor for the i-th codeword, bᵢ is a patch of the reflected ambient scene, and n is a patch of the noise image. The attenuation factor may reflect the intensity of the transmitted codeword pattern being diminished as a result of, e.g., diffusion and diffraction before being received at the receiver. The noise may be gaussian or random, or may, for example be dependent on the location in the image. For example, the noise may intensify when moving away from the center of the image 402, or other factors such that the noise may be modeled deterministically.

Because the codeword pattern 404 is known, the device 200 may identify for the patch 420(1) of the image 402 a codeword i from the set of allowable codewords {1, 2, . . . K} which maximizes xᵢ and bᵢ, thereby minimizing the noise. The estimated codeword may then be used to estimate the ambient scene 406 for patch 420(3). With the ambient scene 406 estimated for the plurality of patches, the estimated ambient scene may be used for post-processing the raw depth map, using a guided filter, wherein pixels of the depth map are weighted based in part on their correspondence with the estimated ambient scene. For example, a natural color (e.g., RGB) version of the estimated ambient scene may be used for such a guided filter, or a smoothed near infrared (NIR) version of the estimated ambient scene may be used instead. However, each of these options is flawed. For example, using the RGB estimated ambient scene may introduce registration errors due to calibration and stress, and using the NIR image may introduce errors because it is generally not precisely correlated with the raw depth map.

Accordingly, the example implementations provide for improved post-processing of raw depth maps generated by structured light systems through the use of a mean scene value, such as via a generalized likelihood ratio test (GLRT). The GLRT may be used to estimate a local mean signal level for the ambient scene at each patch. The local mean signal level may then be used to generate a guided filter for post-processing the corresponding patch of the raw depth map. This GLRT mean value may have the benefit of being better correlated with the raw depth map than the NIR image, and further may not require RGB to NIR registration.

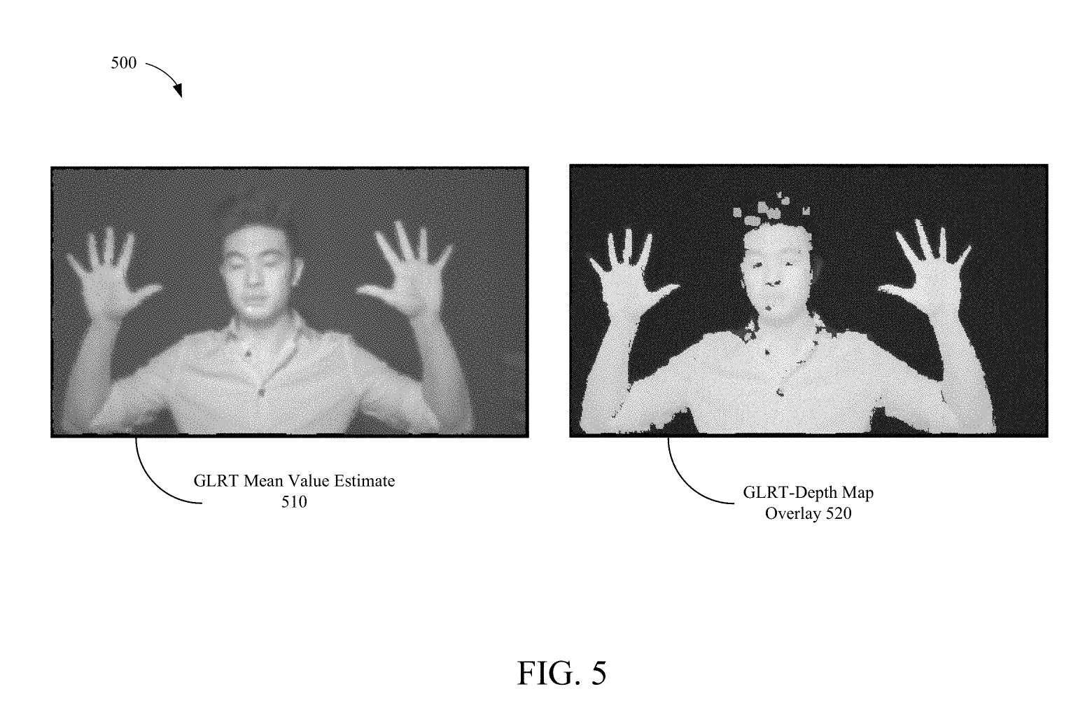

FIG. 5 shows a comparison 500 of a GLRT mean value estimate of an ambient scene with a corresponding depth map, according to the example implementations. As seen with respect to FIG. 5, a GLRT mean value estimate 510 is highly correlated with the raw depth map. The correlation is shown in GLRT-depth map overlay 520, where the depth map is overlaid on the GLRT mean value estimate. Note how the GLRT mean value precisely overlays the depth map. Thus, using the GLRT mean value may be used for creation of a guided filter for processing the raw depth map.

As an example, consider equation 410 for a given patch (or tile), reproduced below:

y=aᵢxᵢ+bᵢ+n, for i∈{1,2, . . . K}

The codeword used for the patch may be estimated as follows:

$$î = arg {max}_{i = 1 , … K} \{ {\sum }_{k = 1}^{N} \frac{( {x}_{ik} - {\overline{x}}_{ι} ) ( {y}_{k} - \overline{y} )}{{σ}_{{x}_{i}} {σ}_{y}} \}$$

where î is the index of the estimated codeword, k is the pixel index of the patch, ranging from 1 to N, xᵢₖ is the value of the k-th pixel of the i-th codeword, x̅ₗ̅ is the mean value of the i-th codeword, yₖ is the value of the received image at the k-th pixel, and ŷ is the mean value of the received image over the patch. σₓ_{ᵢ} and σ_{y} respectively represent the standard deviations of the i-th codeword and the received image over the patch.

After determining the index î of the estimated codeword, the estimated codeword x_{î} may be used for estimating the GLRT mean level b_{î} for the patch of the ambient scene as follows:

$${b}_{î} = \overline{y} - {\overline{x}}_{î} {\sum }_{k = 1}^{N} \frac{( {x}_{î k} - {\overline{x}}_{î} ) ( {y}_{k} - \overline{y} )}{{σ}_{{x}_{î}}^{2}}$$

These estimated mean levels may be used for generating an image B. The image B may have an equal size and resolution as the ambient scene (such as ambient scene 406). Each pixel in B has a value reflecting a corresponding estimated mean level of the patch to which that pixel belongs. Thus, for example, considering the patches 420 of FIG. 4, each pixel in a corresponding patch of B may have a value b_{î} corresponding to the estimated GLRT mean level of the patch 420(3) of the ambient image 406.

After the codewords have been estimated, and the image B constructed, the codewords and image may be used for generating a filter kernel, such as a joint bilateral filter kernel, for post-processing the raw depth map. More particularly, the filter kernel may be given by w(i,j), representing the post-processing weight to be applied at a pixel i due to a pixel j. An example w(i,j) may be given as:

$$w ( i , j ) = {K}_{i}^{- 1} exp ( - \frac{{\vert \vert {𝓅}_{i} - {𝓅}_{j} \vert \vert}^{2}}{2 {σ}_{𝓅}^{2}} ) exp ( - \frac{{\vert \vert {B}_{i} - {B}_{j} \vert \vert}^{2}}{2 {σ}_{B}^{2}} )$$

where Kᵢ is a scaling factor related to pixel i, pᵢ is the pixel location of pixel i, pⱼ is the pixel location of pixel j, σₚ is a pixel proximity-related smoothing component, Bᵢ is the value of the image B (which may be denoted as a matrix) at pixel i (similarly with Bⱼ and pixel j), and σₚ is a pixel intensity-related smoothing component. Thus, the contribution of pixel j to pixel i's weight decays exponentially with respect to pixel distance. Further, this contribution decays exponentially with respect to an absolute difference between the respective estimated mean values of the ambient scene at the patches corresponding to pixels i and j. σₚ and σ_{B} may be selected to adjust the respective contributions of distant pixels and pixels of differing intensity.

Such a filter kernel may be used for generating the post-processing filter. For example, a post-processing filter based on the filter kernel may determine the post-processed value of a given pixel by summing the post-processing weights for pixels in a region, such as a window, surrounding the given pixel. The post-processing filter may also normalize the summed post-processing weights, for example to preserve the energy of the raw depth map.

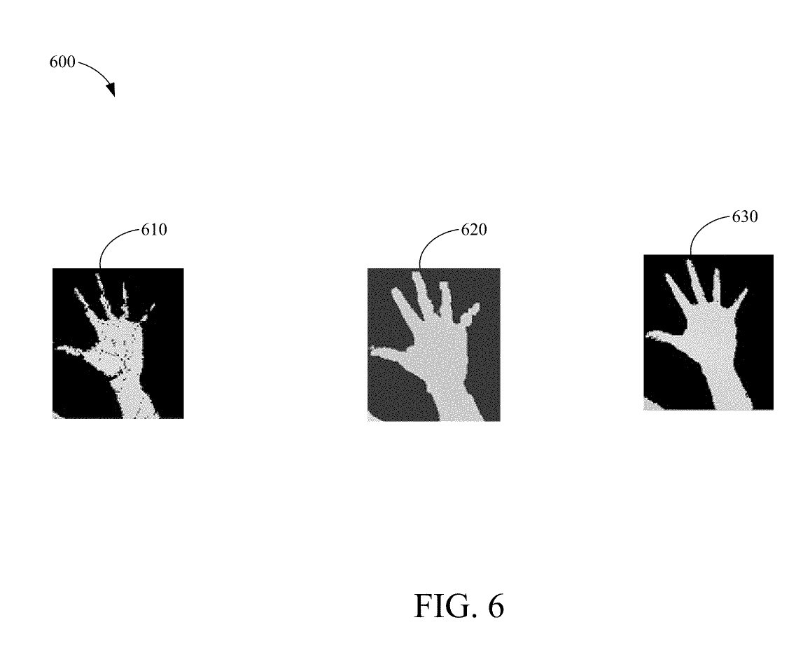

Use of such a post-processing filter may reduce the errors resulting from conventional processing of raw depth maps, such as shown and described above. For example, FIG. 6 shows a comparison 600 of a raw depth map with two post-processed depth maps. More particularly, FIG. 6 shows a first image 610 corresponding to the raw depth map at the region 411, and a second image 620 corresponding to the region 411 post processed using guided filter based on an NIR image. FIG. 6 also shows a third image 630 corresponding to the region 411. This third image 630 reflects a raw depth map processed using a GLRT mean estimate, such as GLRT mean value estimate 510, according to the example implementations described above. Note that the third image 630 does not include the noise reflected in the raw depth map of first image 610, and further the third image does not reflect the missing and inaccurate signal data of the second image 620, particularly regarding the shape and contours of the fingers. Instead, the fingers depicted in the third image 630 are more complete, less noisy, and more accurately reflect the depth of the ambient scene.

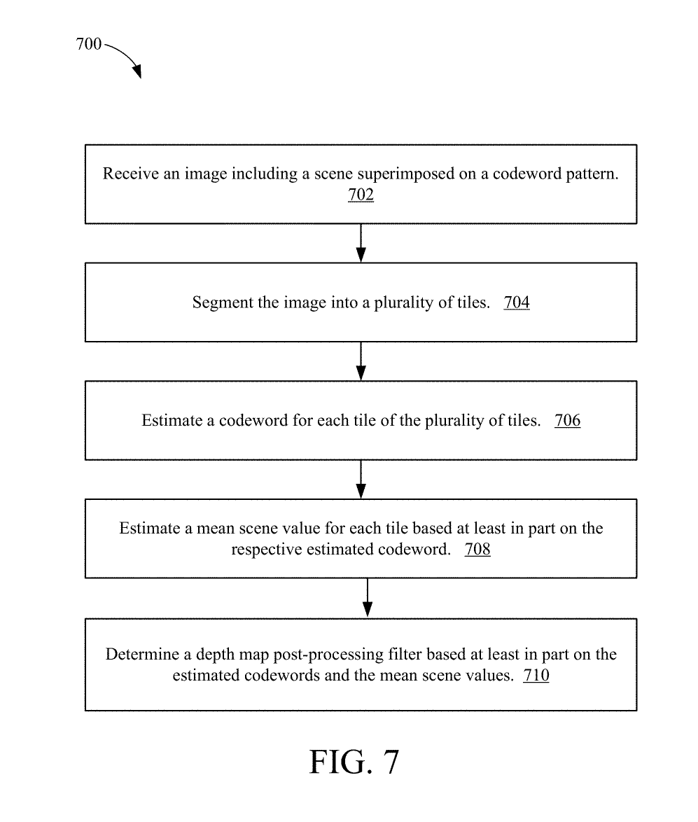

FIG. 7 is an illustrative flow chart depicting an example operation 700 for determining a depth map post-processing filter, according to some implementations. The operation 700 may be performed by any suitable device, such as using the structured light system 100 of FIG. 1, or the device 200 of FIG. 2. With respect to FIG. 7, an image may be received, the image including a scene superimposed on a codeword pattern (702). For example, the image may be received using receiver 108 of FIG. 1, or receiver 202 or camera controller 210 of device 200. The received image may be segmented into a plurality of tiles (or patches) (704). For example, the image may be segmented using the camera controller 211 or ISP 212, or by executing the instructions 208 of device 200. A codeword may be estimated for each of the plurality of tiles (706). For example, the codewords may be estimated by executing the instructions 208, or using the library of codewords 209 of device 200. An estimated mean scene value may be estimated for each tile based at least in part on the respective estimated codeword (708). For example, the mean scene values may be estimated by executing the instructions 208 or using the library of codewords 209 of device 200. Further, the mean scene values may be estimated using a GLRT, as discussed above. A depth map post-processing filter may then be determined based at least in part on the estimated codewords and the mean scene values (710). For example, the filter may be determined by executing the instructions 208 of device 200. The depth map post-processing filter may be a joint bilateral filter and may have a filter kernel as discussed above which assigns weights to each pixel based on the mean scene values and locations of other pixels.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 206 in the example device 200 of FIG. 2) comprising instructions 208 that, when executed by the processor 204 (or the camera controller 210 or the ISP 212), cause the device 200 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 204 or the ISP 212 in the example device 200 of FIG. 2. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. For example, while the structured light system is described as using NIR, signals at other frequencies may be used, such as microwaves, other infrared, ultraviolet, and visible light. Additionally, the functions, steps or actions of the method claims in accordance with aspects described herein need not be performed in any particular order unless expressly stated otherwise. For example, the steps of the described example operations of FIG. 7, if performed by the device 200, the camera controller 210, the processor 204, and/or the ISP 212, may be performed in any order and at any frequency. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

What is claimed is:

1. A method for determining a depth map post-processing filter for a structured light (SL) system, comprising:
receiving an image comprising a scene superimposed on a codeword pattern;
segmenting the image into a plurality of tiles;
estimating a codeword for each tile of the plurality of tiles;
estimating a mean scene value for each tile based at least in part on the respective estimated codeword; and
determining the depth map post-processing filter based at least in part on the estimated codewords and the mean scene values.

2. The method of claim 1, wherein estimating the mean scene value for each tile comprises estimating the mean scene value based at least in part on a generalized likelihood ratio test (GLRT).

3. The method of claim 1, further comprising applying the depth map post-processing filter to a raw depth map corresponding to the image.

4. The method of claim 3, wherein determining the depth map post-processing filter comprises determining a joint bilateral filter based at least in part on a filter kernel, the filter kernel specifying, for each pixel of the raw depth map, a post-processing weight to be applied due to each of a plurality of second pixels.

5. The method of claim 4, wherein, for each given pixel of the raw depth map, the post-processing weight to be applied due to each second pixel is based on first distances between the given pixel and each respective second pixel.

6. The method of claim 5, wherein the first distances are negatively correlated with the post-processing weights.

7. The method of claim 4, wherein, for each given pixel of the raw depth map, the post-processing weight to be applied due to each second pixel is based on mean scene differences between a first mean scene value for a first tile corresponding to the given pixel, and respective second mean scene values for second tiles corresponding to each respective second pixel.

8. The method of claim 7, wherein the mean scene differences are negatively correlated with the post-processing weights.

9. The method of claim 1, wherein estimating the codeword comprises, for each tile, determining the codeword which maximizes a codeword fit metric.

10. The method of claim 9, wherein the codeword fit metric is based at least in part on first differences between each pixel of a tile and a mean value of the tile, and on second differences between each pixel of a candidate codeword and a mean value of the candidate codeword.

11. A device configured to determining a depth map post-processing filter for a structured light (SL) system, comprising:
one or more processors; and
a memory coupled to the one or more processors and including instructions that, when executed by the one or more processors, cause the device to:
receive an image comprising a scene superimposed on a codeword pattern;
segment the image into a plurality of tiles;
estimate a codeword for each tile of the plurality of tiles;
estimate a mean scene value for each tile based at least in part on the respective estimated codeword; and
determine the depth map post-processing filter based at least in part on the estimated codewords and the mean scene values.

12. The device of claim 11, wherein execution of the instructions to estimate the mean scene value for each tile further causes the device to estimate the mean scene value based at least in part on a generalized likelihood ratio test (GLRT).

13. The device of claim 11, wherein the instructions further execute to apply the depth map post-processing filter to a raw depth map corresponding to the image.

14. The device of claim 13, wherein the depth map post-processing filter is a joint bilateral filter based on a filter kernel, the filter kernel specifying, for each pixel of the raw depth map, a post-processing weight to be applied due to each of a plurality of second pixels.

15. The device of claim 14, wherein, for each given pixel of the raw depth map, the post-processing weight to be applied due to each second pixel is based on first distances between the given pixel and each respective second pixel.

16. The device of claim 15, wherein the first distances are negatively correlated with the post-processing weights.

17. The device of claim 14 wherein, for each given pixel of the raw depth map, the post-processing weight to be applied due to each second pixel is based on mean scene differences between a first mean scene value for a first tile corresponding to the given pixel and respective second mean scene values for second tiles corresponding to each respective second pixel.

18. The device of claim 17, wherein the mean scene differences are negatively correlated with the post-processing weights.

19. The device of claim 11, wherein execution of the instructions to estimate the codeword further causes the device to determine, for each tile, the codeword which maximizes a codeword fit metric.

20. The device of claim 19, wherein the codeword fit metric is based at least in part on first differences between each pixel of a tile and a mean value of the tile, and on second differences between each pixel of a candidate codeword and a mean value of the candidate codeword.

21. A non-transitory computer-readable medium storing one or more programs containing instructions that, when executed by one or more processors of a device, cause the device to:
receive an image comprising a scene superimposed on a codeword pattern;
segment the image into a plurality of tiles;
estimate a codeword for each tile of the plurality of tiles;
estimate a mean scene value for each tile based at least in part on the respective estimated codeword; and
determine a depth map post-processing filter based at least in part on the estimated codewords and the mean scene values.

22. The non-transitory computer-readable medium of claim 21, wherein execution of the instructions to estimate the mean scene value for each tile further causes the device to estimate the mean scene value based at least in part on a generalized likelihood ratio test (GLRT).

23. The non-transitory computer-readable medium of claim 21, wherein execution of the instructions further causes the device to apply the depth map post-processing filter to a raw depth map corresponding to the image.

24. The non-transitory computer-readable medium of claim 23, wherein the depth map post-processing filter is a joint bilateral filter based on a filter kernel, the filter kernel specifying, for each pixel of the raw depth map, a post-processing weight to be applied due to each of a plurality of second pixels.

25. The non-transitory computer-readable medium of claim 24, wherein, for each given pixel of the raw depth map, the post-processing weight to be applied due to each second pixel is based on first distances between the given pixel and each respective second pixel.

26. The non-transitory computer-readable medium of claim 25, wherein the first distances are negatively correlated with the post-processing weights.

27. The non-transitory computer-readable medium of claim 24, wherein, for each given pixel of the raw depth map, the post-processing weight to be applied due to each second pixel is based on mean scene differences between a first mean scene value for a first tile corresponding to the given pixel, and second mean scene values for second tiles corresponding to each respective second pixel.

28. The non-transitory computer-readable medium of claim 27, wherein the mean scene differences are negatively correlated with the post-processing weights.

29. The non-transitory computer-readable medium of claim 21, wherein execution of the instructions to estimate the codeword further causes the device to determine, for each tile, the codeword which maximizes a codeword fit metric, the codeword fit metric based at least in part on first differences between each pixel of a tile and a mean value of the tile, and on second differences between each pixel of a candidate codeword and a mean value of the candidate codeword.

30. A device configured to determine a depth map post-processing filter for a structured light (SL) system, comprising:
means for receiving an image comprising a scene superimposed on a codeword pattern;
means for segmenting the image into a plurality of tiles;
means for estimating a codeword for each tile;
means for estimating a mean scene value for each tile based at least in part on the respective estimated codeword; and
means for determining the depth map post-processing filter based at least in part on the estimated codewords and the mean scene values.
